(19) United States
(12) Patent Application Publication
(10) Pub. No.: US 2022/0169915 A1
(43) Pub. Date: Jun. 2, 2022

(54) PROPPANT AND METHOD OF MANUFACTURING A PROPPANT

(71) Applicants: SWANSEA UNIVERSITY, Swansea West Glamorgan (GB); GLASS TECHNOLOGY SERVICES LIMITED, Sheffield South Yorkshire (GB)

(72) Inventors: Andrew BARRON, Swansea West Glamorgan (GB); Covadonga CORREAS LOPEZ, Madrid (ES); Virginia GOMEZ JIMENEZ, Navarra (ES); Robert Gordon IRESON, Sheffield South Yorkshire (GB); Malcolm David GLENDENNING, Sheffield South Yorkshire (GB); Martyn William MARSHALL, Sheffield South Yorkshire (GB); Christopher Paul HOLCROFT, Sheffield South Yorkshire (GB)

(21) Appl. No.: 17/504,441

(22) Filed: Oct. 18, 2021

Related U.S. Application Data
(63) Continuation of application No. 16/324,122, filed on Feb. 8, 2019, now abandoned.

(30) Foreign Application Priority Data
Aug. 8, 2016 (GB) 1613603.8

(51) Int. Cl. C09K 8/80; C03C 12/00; C03C 23/00; C03B 19/10

(52) U.S. Cl. CPC C09K 8/80; C03B 19/1095; C03C 23/007; C03C 12/00

(57) ABSTRACT

The present invention concerns a method for manufacturing a proppant for a particular stimulation fluid, or for manufacturing a stimulation fluid for a particular proppant. The present invention also concerns a proppant for hydrocarbon stimulation, wherein the proppant comprises a plurality of amorphous spherical glass particles which have not undergone any further chemical or thermal treatment, a method of preparing the proppant, and uses of the proppant in hydrocarbon stimulation.

### FIELD OF THE INVENTION

The present invention relates to a method of manufacturing a proppant for use with a particular stimulation fluid, or a method of manufacturing a stimulation fluid for use with a particular proppant. The present invention also relates to a proppant. In particular, though not exclusively, it concerns a glass proppant for fracture stimulation.

### BACKGROUND OF THE INVENTION

Hydraulic fracturing, also known as fracking, traditionally requires a mixture of pressurized water, proppant, and chemical additives. Proppants are small particulates, such as sand or ceramics, which are forced into the fractures, such that they are retained there and “prop” the fracture open to facilitate gas and/or oil extraction after pumping ceases. As such, the proppant is used to access the gas and/or oil in the reservoir. Successful location of the proppant and its ability to survive the pressure and chemistry within the reservoir has the potential to extend the life expectancy of the well.

One function of the chemical additives is to increase the viscosity of the water, such that it can transport the proppant. However, these additives incur cost and have been the subject of environmental objections to fracking. In particular, the use, transport and disposal of chemical additives are a cause for concern for those living close to fracking sites, and to environmental groups.

Furthermore, the volume of water required for hydraulic fracturing is a major concern. Estimates of water use for hydraulic fracturing vary from 10,600 m³ to 21,500 m³ per well (Rahm, B. G. and Riha, S. J., Toward Strategic Management of Shale Gas Development: Regional, Collective Impacts on Water Resources, Environ. Sci. Policy, 2012; 17: 12-23). Particularly in arid areas, the use of such high volumes of water can create conflict with local industries that also require high volumes of water (such as the agriculture industry), and can put undue pressure on local water supplies and water drainage systems.

The water retrieved from the well after the reduction in pumping pressure and after oil and/or gas production is generally contaminated either with additives, with hydrocarbons from the fracking well, or with contaminants from the rock, such as inorganic salts or even bacteria (Maguire-Boyle, S. J. and Barron, A. R., Organic Compounds in Produced Waters from Shale Gas Wells, Environ. Sci: Process Impacts, 2014; 16: 2237-2248). The cost associated with the disposal of this water is generally very high, and accidental release into the environment a constant concern.

Alternatives to hydraulic fracking have been suggested, in particular the use of light petroleum media and pure propane stimulation, but also liquid (or super-critical) C0₂ and other cryogenic fluids, such as liquefied N₂ and cryogenically processed gas. Foam-based fluids, such as acid-based foams, alcohol-based foams or C0₂-based foams, have also been trialed. These alternatives require little or no water. Not only does this relieve the pressure on local water services, but it also reduces the carbon footprint of the well by dramatically reducing the number of trucks needed to remove contaminated waste, as non-hydraulic systems are often near “closed-loop” systems. Furthermore, recovery rates from the well site are significantly improved from less than 30%, as is typical for hydraulic fracking to greater than 90% with non-hydraulic processes.

However, typical commercial proppants are not suitable for use with these non-hydraulic stimulation media (which typically have a lower density and lower viscosity than water). In particular, sand, and many ceramic proppants, cannot easily be suspended in the non-aqueous stimulation medium, either settling out or floating on the surface of the fluid. As a result, known non-hydraulic stimulation techniques also use chemicals to increase the viscosity of the stimulation medium to overcome this problem. This negates the potential environmental, cost, and health and safety benefits of waterless stimulation.

There is therefore a need for a proppant which can be used in hydraulic stimulation where needed, but which can also be utilised in non-hydraulic stimulation, without the need to add viscosity modifying chemicals to the media. The invention is intended to overcome or ameliorate at least some aspects of this problem. Furthermore, the present invention is intended to provide a proppant which can be used in a range of fracturing conditions and at different stages of the fracturing process.

Glass particles are an attractive candidate for use as proppants based on their commercial abundance, ease of manufacture, and low cost. Glass also offers potential to optimise compositional features.

However, the utility of glass particles produced from such raw materials has been hampered by their propensity to fail energetically and catastrophically into small fragments, which effectively “blind” the well.

U.S. Pat. No. 3,497,008 discloses a glass microparticle proppant, which has high sphericity and roundness, and a smooth surface. However, these microparticles have low mechanical strength. GB patent No. 1,100,110 also discloses a spherical glass particle for use as a proppant, however the particle size range specified (0.42 mm-4.76 mm) is not compatible for use with low density fluids, such as propane. Also, this patent states that the glass proppant can withstand stress as high as 3500 kg/cm² (equivalent to 49,700 PSI). However, more recent studies contradict the strength of the untreated glass proppants observed in this patent. For example, WO 2010/147650 states that larger (1 mm) glass spheres fail at a stress as low as 5000 PSI and that an ion-exchange treatment is required to increase the strength of glass proppants.

In fact, the prior art specifically teaches that in order for glass to be used as a proppant in hydro fracturing processes, it must be subjected to thermal or chemical processes in order to increase the toughness of the glass particulates. For example, Koseski, et al. (U.S. Pat. No. 8,359,886) discloses that the strength of amorphous glass spheres is only 99 MPa (equivalent to 14,500 PSI), and that in order for a glass material to be used as a proppant, it must be heated to a temperature greater than 600° C. for a predetermined time, such that one or more crystalline phases nucleates and grows within the amorphous spherical glass particulate and produces a partially devitrified glass particulate. The glass particulate can be cooled to ambient temperature and the heating step can alter the failure mechanism of the glass particulate from a high energy failure that produces generally fine powder to a lower energy failure that produces generally large fragments. In addition, it is required that one or more crystalline phases nucleates in order to provide the strength required to use the glass as a proppant in hydrofracturing processes. Furthermore, the partially devitrified glass particulate must have a Vickers indentation fracture resistance (VIFR) greater than 1.2 MPa·√m, wherein said VIFR is determined by the expression: VIFR=0.1706(H·√a)Log(4.5a/c), where H is a Vickers hardness value of said glass particulate, a is a diagonal length of an indentation produced from a Vickers hardness test, and c is a crack length extending from the indentation produced from the Vickers hardness test.

In a similar manner, Shmotiev et al. (US Patent Application No. 2009/0082231) discloses that glass must be retained at 870° C.-1110° C. for 8-25 minutes to form a glass-ceramic micro-structure in order for it to meet the requirements of a proppant. Furthermore it is claimed that it is desirable for the proppant to have at least 40% crystalline phase by volume. In addition, it is discloses that a proppant size of 250 μm to 5000 μm is desirable.

Similarly, CA 2,707,877 discloses an invention whereby the glass must have a specific composition as well as a specified degree of crystallisation in order to achieve sufficient proppant strength.

Hellmann et al. (U.S. Pat. No. 8,193,128) discloses a process of using molten salt ion exchange to treat particles such as spherically-shaped soda-lime-silica glass particles. The performance of the proppant requires that molten salt ion exchange between the glass particle and a molten salt selected from the group consisting of alkali salts, alkaline earth salts, especially Li₂0 and K₂0. It also requires that the resulting proppant should produce minimum fines. As used therein, the term “fines” refers to particles that have a size of about 150 μm or less.

Graham and Kiel (U.S. Pat. No. 3,497,008) discloses that a glass proppant may be employed if the particles have the configuration of cylinders, rods, parallelepipeds, prisms, cubes, plates, or any other configuration which have linear elements on a surface which are oppositely disposed and parallel. The necessity for linear elements on the surface is based on tests which showed that while individual glass spheres satisfactorily resist crushing under moderate stresses when placed in contact with a plane surface that deforms slightly, thereby spreading the load over a substantial area of the sphere, when placed in multilayer packs, glass spheres shatter more readily since the entire load is concentrated upon extremely small points of contact. The generation of fines from shattered spheres is disclosed as being highly objectionable, since the fines cause a severe loss of proppant permeability, because of their tendency to plug the interstices of the remaining proppant particles. Thus, this reference suggests that spherical glass proppants are deemed unsatisfactory. The prior art teaches the use of crystalline glass materials that have undergone some further heat or chemical treatment to improve their strength. Furthermore, the prior art teaches that particles under 150 μm are considered as fines and, as such, represent a damaging influence to the reservoir and the successful production of oil and/or gas from a reservoir.

The issue of reducing proppant density to aid transport within a stimulation fluid is addressed within patent WO 00/05302, where the solution is to incorporate small glass particles within a polymer binder.

### SUMMARY OF THE INVENTION

The present inventors have developed a method of selecting a proppant having properties that are suitable for use with a particular stimulation fluid, such as a non-hydraulic stimulation fluid, or of selecting a stimulation fluid suitable for use with a particular proppant.

According to a first aspect of the invention, there is provided a method comprising determining a relationship between a suspension velocity of a proppant in a stimulation fluid and a proppant property of the proppant, selecting a suspension velocity corresponding to a proppant having a proppant property known to be transportable in the stimulation fluid, and determining, using the relationship and the selected suspension velocity, either: a desired proppant property for a particular stimulation fluid, or a desired stimulation fluid property for a particular proppant.

For a proppant to be suitable for use in a particular stimulation fluid, it is important that the proppant is transportable in the particular fluid, that is, it is important that the proppant does not settle or float. For a particular combination of stimulation fluid and proppant, there will be a suspension velocity, or range of suspension velocities, for which the proppant is transportable in the fluid, without settling or floating. The relationship between the suspension velocity of the proppant in a stimulation fluid and a proppant property of the proppant can therefore be used to determine either a desired proppant property for a particular stimulation fluid or a desired stimulation fluid property for a particular proppant. By manufacturing proppant particles according to the desired proppant properties for a particular stimulation fluid, it is possible to make proppant particles that should be effectively transported by the stimulation fluid.

As the viscosities of potential stimulation fluids (for instance water, light alkanes, or halogenated alkanes) differ, it is advantageous to be able to select a proppant having suitable properties which will work with the desired stimulation fluid, as well as the rock type. In this way, a proppant may be designed which is capable of transporting proppant particles in aqueous or non-aqueous media without the need for viscosity modifying additives. The method allows for the selection of a proppant from potential proppants having a wide range of diameters and densities, which allows a proppant to be selected which is suitable not only for the stimulation fluid and rock type, but also can be tailored to other operational parameters, such as, the type and depth of the well, and the cost and effectiveness of the proppant. The method allows for proppants having a wide range of properties to be selected, for example, small high density particles (such as may be of particular use with rock of low permeability, such as shale), or larger, less dense particles (which can be desirable for use with rocks of higher permeability, such as sandstone, and which would allow the gas and/or oil from the well to permeate through the proppant pack more rapidly).

The relationship may be determined based on a known proppant having a proppant property that is known to be transported in the stimulation fluid. The known proppant may be based on empirical data which shows that the known proppant is transportable in the stimulation fluid. The known proppant may comprise sand, because it is known that sand may be transportable in certain stimulation fluid. For example, high viscosity “gel” stimulation fluid (containing cross-linked polymers, such as, guar gum) may be used to transport 20/30 mesh sand proppant; high viscosity stimulation fluids (containing other additives) in general may be used to transport 30/50 mesh sand proppant; and slick water (that is, water without viscosity modifiers) may be used to transport 40/70 mesh sand proppant.

The proppant property of the known proppant may comprise one or more of: a proppant density, and a proppant particle diameter.

The stimulation fluid may have a known density.

The relationship may be based on Newton's equation, that is:

$${V}_{s} = {1.74 [ g \cdot d \cdot ( \frac{{ρ}_{p} - {ρ}_{f}}{{ρ}_{f}} ) ]}^{\frac{1}{2}} ,$$

where, Vₛ is the suspension velocity, pₚ is the density of the proppant, p_{f} is the density of the fluid, g is the acceleration due to gravity, and d is the diameter of the proppant.

Alternatively, the relationship may be based on Stoke's law.

Newton's equation applies for turbulent flow at high Reynolds numbers and high particle concentrations. Stokes' law applies to the frictional force (also called the drag force) exerted on spherical objects at low Reynolds numbers (that is, very small particles) in a viscous fluid. For a proppant, Newton's equation is generally more applicable since the proppant concentration is generally high and turbulent flow is observed.

The selected suspension velocity may be in the range of 0.04 m s⁻¹ and 0.25 m s⁻¹, or 0.01 m s⁻¹ and 0.16 m s⁻¹.

The desired stimulation fluid property may comprise a density of the stimulation fluid.

The desired proppant property may comprise one or more of: a desired average diameter of particles of the proppant; and a desired density of particles of the proppant. By manufacturing proppant particles according to the desired proppant properties for a particular stimulation fluid, it is possible to make proppant particles that should be effectively transported by the stimulation fluid.

The method may further comprise determining a plurality of proppant properties for the particular stimulation fluid, each proppant property corresponding with a plurality of suspension velocities known to be transportable in the stimulation fluid.

The plurality of proppant properties may be a range of diameters of particles of the proppant corresponding with a range of suspension velocities known to be transportable in the particular stimulation fluid.

Ideally, the proppant particles should be manufactured with proppant properties (such as an average diameter, range of diameters, density, or range of densities) which closely match the desired proppant properties in order for the proppant to be successfully transported in the particular stimulation fluid.

A lower limit on the range of diameters may be determined based on the minimum suspension velocity known to be transportable. Alternatively, the lower limit on the range of diameters may be based on conductivity of the proppant when packed. For gas to flow from the rock, Darcy's law indicates that, in use, packed proppant should have a higher conductivity that the permeability of the rock.

The range of diameters may be based on the crush strength of the proppant at a given diameter, for example, to prevent fracturing of the glass particles of the proppant which could produce fine particles which can block the gaps between proppant particles and thus reduce conductivity. Smaller proppants have been found to be more resistant to crushing, such that lower crush strengths are sought to support a fracture. The range of diameters may be based on conductivity of the proppant of a given diameter when packed and the resistance to crushing of proppant of the given diameter. Shale rock types have a low permeability, and hence smaller diameter proppants may be used while still enabling gas to be extracted from the shale rock, and smaller diameter proppants also are more resistant to crushing.

An upper limit on the range of diameters may be determined based on a maximum suspension velocity known to be transportable in the stimulation fluid.

The plurality of proppant properties may be a range of densities of particles of the proppant based on a range of suspension velocities known to be transportable.

The method may further comprise selecting, from the plurality of proppant properties, one or more proppant properties each meeting an operational requirement. The operational requirement may balance one or more of: a cost of the proppant, a size of a fracture; a depth of a fracture; and productivity (which is related to conductivity of the proppant in use).

It may be desirable to strike a balance between various operational parameters, such as cost and productivity: Where productivity is key, it may be decided to select a lower density proppant in order to improve conductivity, even though the proppant might cost more. In other cases, cost may be a more significant factor and it may be chosen to select a cheaper, higher density proppant (such as a standard soda-lime-silicate composition) even though doing so will require smaller diameter particles (to avoid crushing) which will tend to reduce conductivity (and therefore productivity).

In other cases, the depth of the well may mean that the proppant will experience significant pressures and it is a priority to minimize crushing. For example, a proppant with an average diameter of 400 μm might provide optimum conductivity. However, as the proppant is destined for a deep well where the proppant is likely to experience significant pressure (a typical shale gas well may have a pressure of between 41-55 MPa (6000-8000 psi), a smaller proppant might be chosen in order to minimise the risk of the proppant crushing, even though this will reduce the conductivity.

In some instances, more than one proppant will be selected, each proppant selected having a different proppant property. For example, a low cost smaller proppant may be selected for initial pumping into a well, which will penetrate furthest into the many small fractures, before pumping a second, larger and more expensive proppant nearer the end of the stimulation processes, which will end up nearer the well bore where the fractures are bigger and where higher conductivity will make a bigger different to productivity (as a higher percentage of the gas will flow through the area in proximity to the well bore).

The method may further comprise manufacturing a proppant having the desired proppant property, or manufacturing a stimulation fluid having the desired stimulation fluid property.

The method may be a computer-implemented method. The method may be carried out using a processor.

According to a second aspect of the invention, there is provided a stimulation fluid having a property determined using the method according to the first aspect.

According to a third aspect of the invention, there is provided a proppant having a property determined using the method according to the first aspect

Using the method according to the first aspect, the present inventors have found that amorphous spherical glass proppants, which have not undergone any further heat or chemical treatments, have properties which make them suitable for a variety of hydraulic and non-hydraulic fracturing processes, particularly where non-water-based stimulation fluids (e.g. propane) are used, and in the absence of (chemical, i.e. not inert) additives. Such a proppant has been found to be particularly useful for the fracturing of shale.

Accordingly, in a fourth aspect of the invention there is provided a proppant for hydrocarbon stimulation, wherein the proppant comprises a plurality of amorphous spherical glass particles which have not undergone any further chemical or thermal treatment. Proppants of this type are low cost, and have been found to possess a high strength, a high degree of sphericity, and a highly reliable failure behaviour, such that they consistently promote flow and dispersion in the hydrocarbon stimulation fluid medium. Furthermore, the proppant may be chosen to have certain other physical features, such as size and density, which is matched to the density of the hydrocarbon stimulation fluid in order to mitigate settling during placement.

As used therein, the term “fracture stimulation” refers to any type of hydraulic or non-hydraulic fracturing process. Preferably, the invention is for use in a non-hydraulic fracturing process. Furthermore, it is preferred that the invention is used in a process which employs a non-water-based stimulation fluid, such as a fluid comprising C₁-C₃₀ alkanes (e.g. liquid petroleum gas (LPG) comprising C₁₀-C₂₂ alkanes), particularly propane.

The glass proppant of the present invention can be transported without settling during transport. This can reduce the pressure at which the proppant must be pumped into the well and reduces or eliminates the need for additives to aid transport. As used herein, the term “additive” is intended to refer to the non-natural, potentially hazardous additives generally used in traditional hydraulic fracturing techniques. The invention does not preclude the presence of components other than the fluid medium and the proppant, but intends for these components to be environmentally benign in the context of ground water or surface contamination, for instance, nitrogen gas or carbon dioxide gas may be present, as may non-toxic additives such as glycerine, or components recovered from the hydrocarbon source, such as C₄-C₂₀ hydrocarbons. However, in some cases even these additives will be absent.

The transport mechanism during the fracturing process can be suspension, saltation or reputation (Coker, C. E. and Mack, M. G., Proppant Selection for Shale Reservoirs: Optimizing Conductivity, Proppant Transport and Cost, SPE-167221-MS, 2013). Often, the proppant can be transported in a fluid medium at velocities in the range 0.04 m s⁻¹-0.25 m s⁻¹. Additionally or alternatively, the proppant may have a suspension velocity in the range 0.04 m s<−1>-0.13 m s<−1>. At these velocities the glass proppant of the present invention has been found to transport well, without settling or floating, even in the absence of chemical additives. The settling behaviour of suspended proppant can be described using Stokes Law:

$${v}_{s} = \frac{g ( {ρ}_{p} - {ρ}_{fluid} ) {d}^{2}}{18 {μ}_{fluid}}$$

(vₛ=settling velocity, g=gravitational constant, pₚ=density of proppant, p_{fluid}=density of fluid, d=proppant diameter and μ=fluid viscosity).

The transport velocity of the proppant can be controlled through selection of the particle diameter of the proppant and the density. By balancing the diameter and density, a range of particles can be used without foregoing benefits of the invention, particularly the ability to transport the proppant particles in aqueous or non-aqueous media without the need for viscosity modifying additives. As such, the invention provides for the use of small high density particles, such as may be of particular use with rock of low permeability, such as shale, and for larger, less dense particles which can be desirable for use with rocks of higher permeability, such as sandstone, and which would allow the gas and/or oil from the well to permeate through the proppant pack more rapidly. The ability to provide particles in a range of diameters and densities allows these to be tailored directly to the stimulation fluid being used. As the viscosities of the possible stimulation fluids (for instance water, light alkanes, or halogenated alkanes) differ, it is advantageous to be able to select a proppant, which works with the stimulation fluid, as well as the rock.

In one embodiment of the invention, the density and average diameter of the glass particles may be chosen such that the proppant can be transported in a fluid medium at velocities in the range of 0.04 m s⁻¹-0.25 m s⁻¹. In another embodiment, the density and average diameter of the glass particles may be chosen such that the proppant can be transported in a fluid medium at velocities in the range of 0.01 m s⁻¹-0.16 m s⁻¹.

The glass particles of the proppant often have a particle diameter in the range 1-800 μm, often in the range 1 μm-500 μm, 20 μm-400 μm, 40 μm-500 μm or 50 μm-300 μm, or in the range 1 μm-65 μm, 45 μm-90 μm, 75 μm-100 μm, 50 μm-125 μm or 100 μm-250 μm, preferably 100 μm-250 μm (according to ISO 13503-2 § 6). As used herein the term “particle diameter” is intended to refer to the mean diameter of the particles in the proppant across the longest axis, although the particles of the invention will generally be of uniform shape, and generally spherical.

In particular, it has been found that particle diameters of greater than 250 μm are most effective for sandstone or limestone stimulation, as these substrates are porous relative to shale. For shale, smaller particle diameters, in particular in the range 100 μm-250 μm, are preferred. It has been found that very small particle diameters, for instance below 100 μm or 50 μm, whilst retaining their excellent transport properties are of less utility during stimulation as the proppant permeability drops to a point where fracture conductivity is unacceptably low as permeation through the proppant is hindered.

Often, the proppant will have a density in the range 0.9 g cm⁻³-2.5 g cm⁻³ (according to ISO 13503-2 § 10). At these densities, transport has been found to be optimised. Where the density is lower than 0.9 g cm⁻³, the particle diameters required to prevent floating of the proppant are sufficiently high that they could only be used with the most porous of rocks. As densities lower than 2.0 g cm⁻³ are often difficult to achieve with glass substrates, it will often be the case that the density will be in the range 2.0 g cm⁻³-2.5 g cm⁻³. Where the density is higher than 2.5 g cm⁻³, only the smallest of particles can be used if the proppant is to be transported without settling unless large quantities of additives are used (hence why additives are used), but at these particle sizes permeability of the proppant becomes an issue during oil/gas recovery as fracture conductivity can be unacceptably reduced depending on the relative permeability of the reservoir rock versus the proppant pack.

Often the proppant has a particle size and density relation falling between the upper and lower boundaries shown in either of FIG. 3 or 4. The graph in FIG. 3 illustrates the limits of particle diameter for a given density of proppant for transport using a pure propane stimulation fluid. The graph in FIG. 4 illustrates the limits of particle diameter for a given density of proppant for transport using a liquid petroleum gas (LPG) stimulation fluid having the composition shown in Table 2. Particles falling between the upper and lower boundaries in FIGS. 3 and 4 can be expected to transport well in the relevant stimulation fluid without the need for viscosity modifying particles to prevent floatation or settling.

Transport of the proppant in the stimulation fluids can be improved through the provision of proppant of uniform size, such that it has a low particle size distribution. This also ensures that once the proppant is packed in the rock, gaps will be left between proppant particles ensuring that the gas and/or oil can permeate through the proppant and fracture conductivity is good. As such, the particle size distribution of the proppant is often in the range of 1 μm-500 μm, preferably 40 μm-250 μm, even more preferably 50 μm-125 μm or 100 μm-250 μm.

Proppants of the present invention are resistant to crushing. As such, they prevent fracturing of the glass particles of the proppant to produce fine particles which can block the gaps between proppant particles and thus reduce permeability. The crush strength of the proppant may be in the range 0.01 MPa-55 MPa (2000 psi-8000 psi) (according to ISO 13503-2 § 11). In some cases, in particular where smaller particles (e.g. 1 μm-200 μm or 50 μm-200 μm) are used, the crush strength may be in the range 55 MPa-83 MPa (8000 psi-12000 psi). This is as smaller proppants have been found to be more resistant to crushing, such that lower crush strengths are sought to support a fracture. The strength often needed for a proppant to be resistance to crushing within a fracture can be further enhanced through the use of particles which are highly uniform, for instance in shape and/or size, such that a further benefit of providing a proppant with a low particle size distribution is an improved crush resistance at low particle size distributions. The crush strength of the glass particles may be such that the percentage of fines, measured at 41 MPa (6000 psi), is less than 10%, preferably less than 9% or 8.2%, more preferably less than 6.3% or 4%.

The conductivity of the proppant is preferably 5 mDa-100 mDa when the proppant is used in a hydrocarbon stimulation process, i.e., when used in fracturing.

The glass particles of the proppant have a generally uniform spherical shape. In particular, the glass particles are highly spherical, and possess a sphericity of ≥0.5, 0.6 or 0.7 (according to ISO 13503-2 § 7; J. Getty, Petroleum Engineering, Montana Tech. Overview of Proppants and Existing Standards and Practices). Preferably, the sphericity of the glass particles is ≥0.8, most preferably ≥0.85.

The glass particles of the proppant generally have a smooth surface. In particular, the glass particles have a roundness of ≥0.5, 0.6 or 0.7 (according to ISO 13503-2 § 7; J. Getty, Petroleum Engineering, Montana Tech. Overview of Proppants and Existing Standards and Practices). Preferably, the roundness of the glass particles is ≥0.8, most preferably ≥0.85.

Compositionally, the glass may be selected from a soda-lime silicate glass, a borosilicate glass, or a phosphate glass, although a wide range of virgin and recycled glasses may be used. Preferably, soda-lime silicate glass is used, which may be float glass or container glass. A typical composition for a soda-lime silicate glass comprises: Si0270 wt %-80 wt %, Na20 10 wt %-20 wt %, CaO 7 wt %-12 wt %, Al2O3 0 wt %-2.5 wt %, and MgO 0.1 wt %-5 wt %, preferably S1O2 70 wt %-74 wt %, Na2O 12 wt %-15 wt %, CaO 7 wt %-12 wt %, A12030.05 wt %-2.5 wt %, and MgO 0.5 wt %-4 wt %. Atypical composition for a borosilicate glass comprises: Si0210 wt %-50 wt %, Na20 0 wt %-20 wt %, B20340 wt %-90 wt %. Other suitable borosilicate glass compositions are described in Barlet et al., J Non-Crystalline Solids, 2013, 382, 32-44.

Preferably, the glass is a soda-lime silicate glass, more preferably comprising the following composition: Si0274 wt %, Na20 13 wt %, CaO 10.5 wt %, A12031.3 wt %, and MgO 0.2 wt %.

Alternatively, the glass particles may be made from a range of other glass compositions known in the art, which may include a range of waste materials.

The glass particles of the proppant are amorphous glass particles. As used herein, the term “amorphous” refers to a glass having less than 5 vol % crystalline glass, preferably less than 3 vol %, 2 vol % or 1 vol % crystalline glass, as determined by X-ray diffraction. Most preferably, the glass particles of the invention are essentially free of crystalline glass, i.e. such that no evidence crystalline glass can be observed. A glass having such low levels of crystallinity is believed to improve the crush strength of the glass particles.

In certain embodiments, the glass particles may contain bubbles, pores or voids. Such additional structural features may be used to control the physical properties of the proppant, such as the density of the glass particles, and thus the flow characteristics.

In other embodiments, the glass particles are solid particles. That is, the glass particles are solid particles of amorphous glass and do not contain any inclusions, including bubbles, pores or voids. Preferably, the glass particles of the present invention are solid particles.

In a fifth aspect of the invention there is provided a method of preparing a proppant according to the invention, the method comprising the steps of:
(a) grinding a glass into a fine powder;
(b) forming a jet of the fine powder with compressed air;
(c) introducing the jet into a natural gas furnace, such that the jet is positioned in an upward direction; and
(d) collecting spherical glass particles at an elevated location of the furnace.

Preferably, the glass particles of the first aspect of the invention are obtainable by the method of the second aspect of the invention.

Other methods may also be employed to prepare the proppants of the present invention. A common alternative method of producing microspheres is to melt the tip of a glass filaments. This produces a single sphere which remains attached to the filaments. The filaments can then be used to position the microsphere wherever it is desired. However, as each microsphere has to be individually produced, it is not practical for applications where multiple spheres are required. Methods for producing large numbers of microspheres include pouring molten glass into liquid nitrogen, or onto a spinning disc which then flings out droplets that quench as they fly, and another is by passing crushed glass through a plasma. However, many of these methods produce glass having a poor quality surface, which then needs to undergo a chemical etch to improve the quality of the surface. These methods produce a large number of series with a range of sizes. One final method is an inflight melt-quenching method involving dropping crushed glass through a furnace, whereby the crushed glass melts as it drops through the furnace, and surface tension pulls the glass into a sphere which quenches as it drops to the cooler regional of the furnace below.

In a sixth aspect of the invention there is provided a hydrocarbon stimulation medium comprising a proppant according to the first aspect of the invention. The hydrocarbon stimulation medium may be water, although it may also be a non-hydraulic medium, such as one of the alkane mixtures used in light oil stimulation. For instance, the alkane may comprise C₁-C₃₀ alkanes, often C₁-C₁₀ alkanes or C₁-C₅ alkanes. The C₁-C₅ alkane may be one or more of ethane, propane, butane, and pentane, including their regioisomers. The alkanes may also be halogenates, most often with fluorine, but chlorine and bromine substituents may also be present, for example heptafluoropropane.

In many cases, the proppants of the invention will be used in pure propane stimulation (PPS), and so the alkane will comprise propane. Generally the light alkane, or propane in PPS, will be liquefied, both for ease of transport and to ensure that the stimulation fluid reaches the fractures and carries the proppant with it.

The proppants of the invention may also be used in stimulation using liquefied or super-critical CO₂ or any other cryogenic (processed) liquid, e.g., where the fluid consists of either pure CO₂, pure N₂, or a mixture of CO₂ and N₂, or a mixture containing liquefied CO₂ and any other inert gas. The proppants of the invention may also be used in stimulation using foam-based liquids, e.g. consisting of any of water, a foamer, an acid, methanol, N₂ and liquified CO₂, and mixtures thereof.

In a seventh aspect of the invention there is provided the use of a proppant according to the first aspect of the invention, in hydrocarbon stimulation. As described above with reference to the hydrocarbon stimulation medium, often the use will be in non-hydraulic stimulation and often the hydrocarbon stimulation medium will be propane.

In many examples, the hydrocarbon stimulation will be of a substrate selected from shale, sandstone, limestone and combinations thereof. Often the use will be in shale stimulation as shale stimulation has hitherto been the most difficult form of stimulation using non-hydraulic methods.

The use may comprise two stages, in which a first stage uses small, dense particles to prop up the fractures, with a second stage where larger, less dense particles are used for their greater permeability, to ensure maximum recovery of the oil/gas in the well. Larger particles can be used in the later stages of recovery as the fractures are generally larger at this point in the lifecycle of the well.

Unless otherwise stated each of the integers described may be used in combination with any other integer as would be understood by the person skilled in the art. Further, although all aspects of the invention preferably “comprise” the features described in relation to that aspect, it is specifically envisaged that they may “consist” or “consist essentially” of those features outlined in the claims. In addition, all terms, unless specifically defined herein, are intended to be given their commonly understood meaning in the art.

Further, in the discussion of the invention, unless stated to the contrary, the disclosure of alternative values for the upper or lower limit of the permitted range of a parameter, is to be construed as an implied statement that each intermediate value of said parameter, lying between the smaller and greater of the alternatives, is itself also disclosed as a possible value for the parameter.

In addition, unless otherwise stated, all numerical values appearing in this application are to be understood as being modified by the term “about”.

### BRIEF DESCRIPTION OF THE DRAWINGS

In order that the invention may be more readily understood, it will be described further with reference to the following Figures and to the specific examples hereinafter.

FIG. 1 shows a plot of the suspension velocity of sand in water as a function of the diameter of the sand particles.

FIG. 2 shows a plot of suspension velocity as a function of proppant particle diameter for soda-lime silicate glass (SLS) in a propane stimulation fluid, alongside the suspension velocity of sand in water as a function of the size of the sand particles.

FIG. 3 is a graph illustrating the upper and lower limits of proppant diameters that will be transported effectively in propane for a given proppant density.

FIG. 4 is a graph illustrating the upper and lower limits of proppant diameters that will be transported effectively in liquid petroleum gas (LPG) having the composition shown in Table 2 for a given proppant density.

FIG. 5 is a graph comparing the crush strength of a range of proppants according to the invention with sand and carbo (i.e. Carbolite, aluminosilicate proppant) as a function of pressure. The proppants are labelled “GTS” with a composition as identified in Example 1 and numerical values indicating the average diameter of the particles. “Retention %” indicates the percentage of the volume of proppant that is not crushed to fines.

FIG. 6 is a graph comparing the crush strength of a 100 μm diameter proppant according to the invention with 100 μm diameter sand as a function of pressure. “Retention %” indicates the percentage of the volume of proppant that is not crushed to fines.

FIG. 7 is a graph comparing the crush strength of a proppant according to the invention with carbo (i.e. Carbolite, aluminosilicate proppant) as a function of pressure. “Retention %” indicates the percentage of the volume of proppant that is not crushed to fines. It shows that the glass particles of the invention have improved crush strength compared to carbo up to approximately 7000 psi.

FIG. 8 is a graph comparing the crush strengths of a number of proppants according to the invention with bauxite and sand at 6000 psi. “Crush fines %” indicates the percentage of the volume of proppant that is crushed to fines. The graph shows that proppants according to the invention have a greater crush strength and thus produce less fines.

FIG. 9 is a graph comparing the crush strengths of a number of proppants according to the invention with bauxite and sand at 8000 psi. “Crush fines %” indicates the percentage of the volume of proppant that is crushed to fines. The graph shows that certain proppants have a greater crush strength and thus produce less fines.

### DETAILED DESCRIPTION

For a proppant to be suitable for use in a particular stimulation fluid, it is important that the proppant is transportable in the particular fluid, that is, it is important that the proppant does not settle or float. For a particular combination of stimulation fluid and proppant, there will be a suspension velocity, or range of suspension velocities, for which the proppant is transportable in the fluid, without settling or floating.

It has been well established, through experiments, that certain proppants may be transported in particular stimulation fluids, and empirical data is available which can be used to derive a link between the suspension velocity and properties of the proppant (specifically density of the proppant and diameter of a proppant particle) and properties of the stimulation fluid (namely the density of the fluid).

A proppant which has been studied in detail is sand. It is known that sand particles of particular densities and diameters can be successfully transported in stimulation fluids of particular densities. For example, high viscosity “gel” stimulation fluid (containing cross-linked polymers, such as, guar gum) may be used to transport 20/30 mesh sand proppant; high viscosity stimulation fluids (containing other additives) in general may be used to transport 30/50 mesh sand proppant; and slick water (that is, water without viscosity modifiers) may be used to transport 40/70 mesh sand proppant.

A relationship between suspension velocity, the diameter and density of sand particles, and the density of the stimulation fluid can be derived by fitting Newton's equation to empirical sand data, leading to the following relationship:

$${V}_{s} = {1.74 [ g \cdot d \cdot ( \frac{{ρ}_{p} - {ρ}_{f}}{{ρ}_{f}} ) ]}^{\frac{1}{2}} , \qquad ( 1 )$$

where, Vₛ is the suspension velocity, pₚ is the density of the proppant, p_{f} is the density of the stimulation fluid, g is the acceleration due to gravity, and d is the diameter of the proppant.

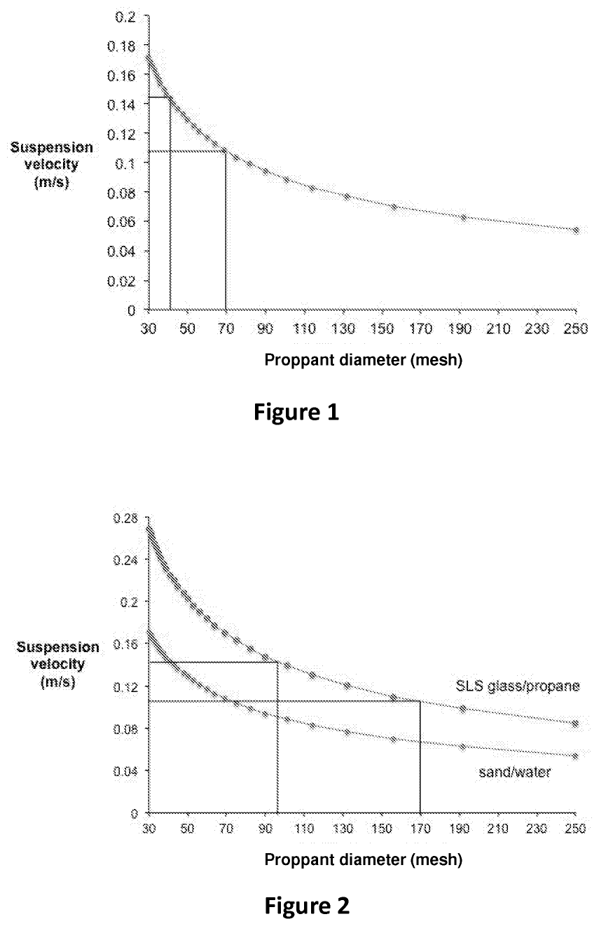

FIG. 1 shows a plot of suspension velocity as a function of a particle size (measured according to the commonly used mesh size criterion) for sand in slick water which has been generated using equation 1.

40-70 mesh sand, which corresponds with sand having particle diameters in the range of about 200 μm to 400 μm, represents a range of sand particle diameters which are readily transported in slick water stimulation fluid using current pumping technology. Sand diameters which are bigger than 40 mesh (approximately 400 μm) are not transported effectively into a fracture because the particles tend to settle. Sand particle having diameters which are smaller than 70 mesh (approximately 200 μm) are difficult to transport because they tend to float on the surface of the water.

The relationship in equation 1 can be used to determine the suspension velocity required to transport 40 mesh sand. As shown in FIG. 1, the suspension velocity for 40 mesh sand would be 0.143 m s<−1>0 and this value can then be used as a guide to the maximum suspension velocity capable of successfully transporting any proppant in any fluid. Suspension velocities above 0.143 m s<−1> are likely to lead to the proppant settling rather than being transported.

The suspension velocity for the 70 mesh sand, determined according to equation 1, is 0.108 m s⁻¹ and this value can then be used as a guide to the minimum suspension velocity capable of successfully transporting any proppant in any fluid. Suspension velocities below 0.108 m s⁻¹ are likely to lead to the proppant floating on the surface of the stimulation fluid rather than being transported.

There may be other criteria which are used to select the lower limit of particle diameters other than the smallest particle diameter which remains pumpable. For example, the lower particle diameter limit may be governed by other considerations, such as, the conductivity of the proppant which may reduce to an unacceptable level should the proppant diameter be too small.

Soda-lime-silicate (SLS) glass materials is a promising material for use as a proppant because SLS can be prepared with a narrow range of particle diameters in a highly spherical form, which is ideal for a proppant for both transport and conductivity. Equation 1 can be used to determine the range of diameters of SLS glass particles which will be transportable in a given stimulation fluid.

The SLS glass has density pp=2500 kg m⁻³. Liquid propane which has a density @ 25° C. pf=493 kg m⁻³ can be shown to be a suitable stimulation liquid. Vₛ is calculated for a series of diameters of glass particles d ranging from 20 μm-600 μm (0.00002-0.0006 m), as shown in Table 1.

TABLE 1
Calculated suspension velocity Vₛ as a function of proppant
diameter d for SLS glass in liquid propane stimulation fluid.

| Mesh | Diameter | Diameter | Suspension velocity, |
|---|---|---|---|
| size | d/μm | d/m | Vₛ/m s⁻¹ |
| 693 | 20 | 0.00002 | 0.0492 |
| 365 | 40 | 0.00004 | 0.0695 |
| 250 | 60 | 0.00006 | 0.0852 |
| 192 | 80 | 0.00008 | 0.0984 |
| 156 | 100 | 0.0001 | 0.110 |
| 132 | 120 | 0.00012 | 0.120 |
| 114 | 140 | 0.00014 | 0.130 |
| 101 | 160 | 0.00016 | 0.139 |
| 90 | 180 | 0.00018 | 0.148 |
| 82 | 200 | 0.0002 | 0.156 |
| 75 | 220 | 0.00022 | 0.163 |
| 69 | 240 | 0.00024 | 0.170 |
| 64 | 260 | 0.00026 | 0.177 |
| 60 | 280 | 0.00028 | 0.184 |
| 56 | 300 | 0.0003 | 0.190 |
| 53 | 320 | 0.00032 | 0.197 |
| 50 | 340 | 0.00034 | 0.203 |
| 48 | 360 | 0.00036 | 0.209 |
| 45 | 380 | 0.00038 | 0.214 |
| 43 | 400 | 0.0004 | 0.220 |
| 41 | 420 | 0.00042 | 0.225 |
| 39 | 440 | 0.00044 | 0.231 |
| 38 | 460 | 0.00046 | 0.236 |
| 36 | 480 | 0.00048 | 0.241 |
| 35 | 500 | 0.0005 | 0.246 |
| 34 | 520 | 0.00052 | 0.251 |
| 33 | 540 | 0.00054 | 0.256 |
| 32 | 560 | 0.00056 | 0.260 |
| 31 | 580 | 0.00058 | 0.265 |
| 30 | 600 | 0.0006 | 0.269 |

The suspension velocities from Table 1 are shown plotted in FIG. 2. For comparison, the suspension velocities of 40/70 sand in slick water are also shown for corresponding particle sizes.

Taking the maximum suspension velocity to be 0.143 m s⁻¹ as determined from the 40/70 sand, we can calculate, using equation 1, that the corresponding maximum particle diameter for the SLS glass that will be transported in propane stimulation fluid is 160 μm (95 mesh). The minimum suspension velocity can be taken to be 0.108 m s⁻¹ as determined from the 40/70 sand, so we can calculate, using equation 1, that the corresponding minimum particle diameters for the SLS glass that will be transported in propane stimulation fluid is 88 μm (170 mesh). Hence, a range of SLS glass particle diameters in the range of 95/170 mesh (around 88 μm-160 μm) can be selected for use in a propane stimulation fluid.

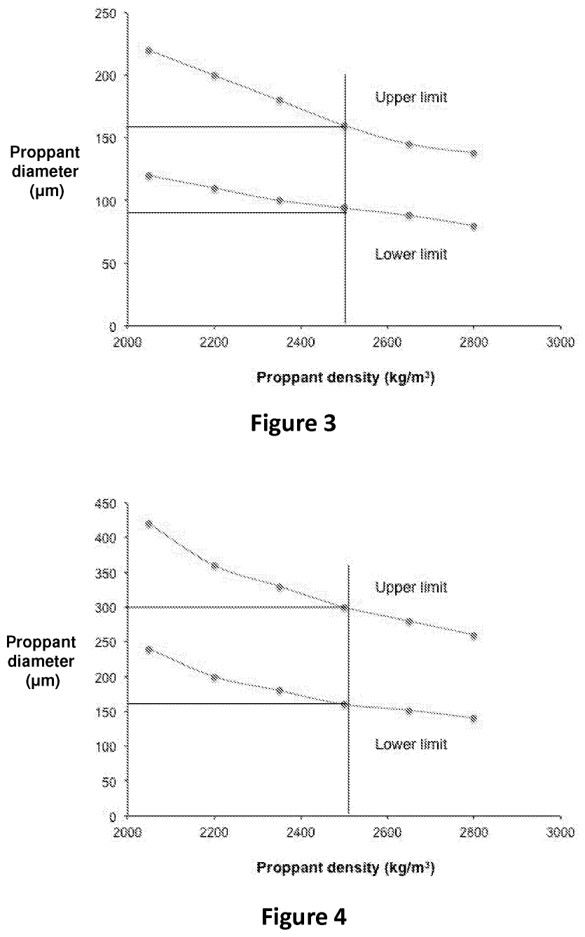

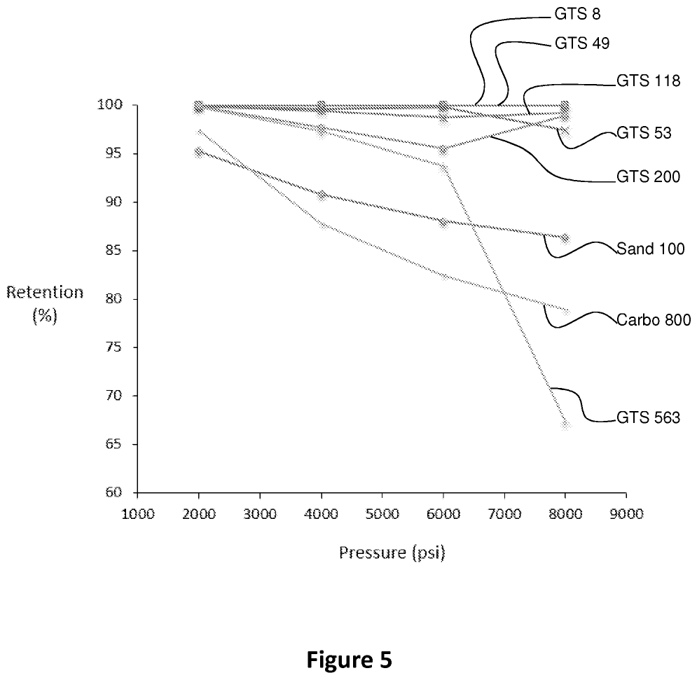

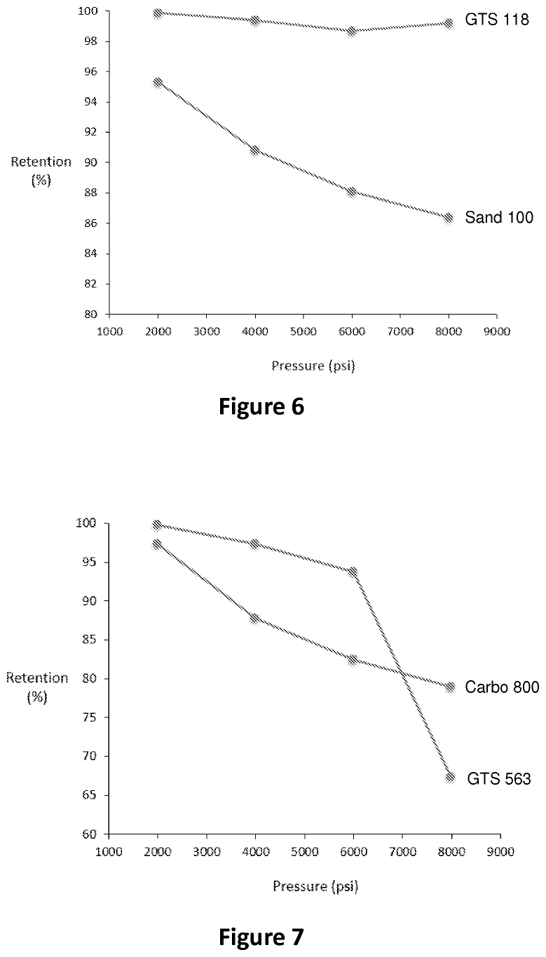

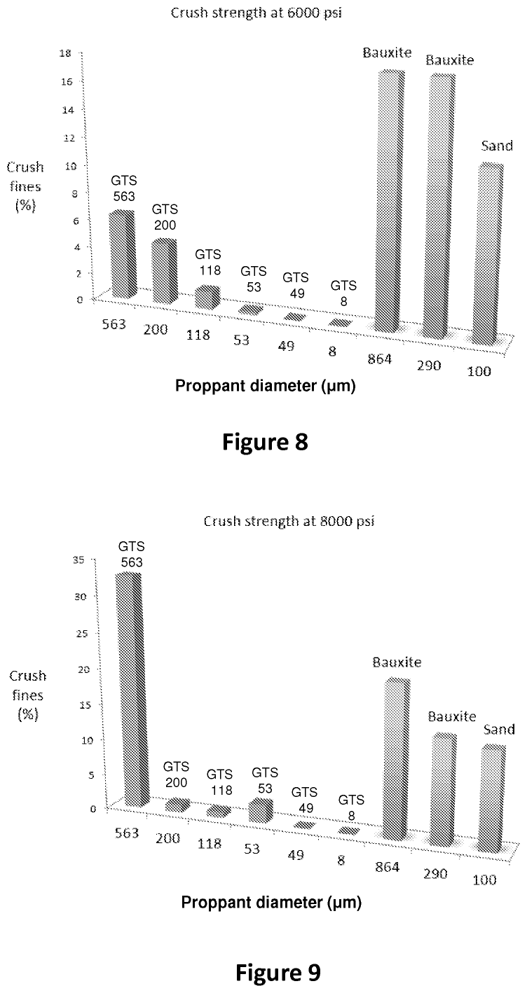

As shown in FIG. 3, Equation 1 can be used to calculate the maximum and minimum proppant particle diameter as a function of proppant densities that will be successfully transported in the propane stimulation fluid (given the criteria that the maximum and minimum suspension velocities may be based on the 40/70 mesh sand data, that is, the maximum suspension velocity is 0.143 m s⁻¹ and the minimum suspension velocity 0.108 m s⁻¹). This shows that for SLS glass, with a density of pₚ=2500 kg m⁻³>, that the minimum SLS glass particle diameter is 88 μm and the maximum SLS glass particle diameter is 160 μm. FIG. 3 illustrates that it is possible to manipulate the proppant particle diameter to meet other needs (such as crush resistance, conductivity, or cost) by selecting a proppant with a different density.

It is desirable to be able to exploit the higher hydrocarbon fluids that are naturally present in natural gas as a stimulation fluid, to avoid the need to transport large quantities of stimulation fluid to the site. The hydrocarbon fluids will have a composition which is similar to the commercial LPG test fluid illustrated in Table 2 which shows the composition of the fluid and the density of the components.

TABLE 2
Composition of LPG test fluid.

| Compounds | | Density | Density fraction |
|---|---|---|---|
| CₙH_{2B+2} (n) | Wt % | (kg/m³) | (kg/m³) |
| C₁₀H₂₂ | 0.101 | 730 | 0.737 |
| C₁₁H₂₄ | 2.024 | 740 | 15.0 |
| C₁₂H₂₆ | 5.732 | 750 | 43.0 |
| C₁₃H₂₈ | 9.995 | 756 | 75.6 |
| C₁₄H₃₀ | 12.757 | 764 | 97.5 |
| C₁₅H₃₂ | 15.606 | 769 | 120 |
| C₁₆H₃₄ | 17.813 | 793 | 141 |
| C₁₇H₃₆ | 18.632 | 777 | 145 |
| C₁₈H₃₈ | 11.932 | 777 | 92.7 |
| C₁₉H₄₀ | 4.452 | 783 | 34.9 |
| C₂₀H₄₂ | 0.849 | 791 | 6.72 |
| C₂₁H₄₄ | 0.103 | 792 | 0.816 |
| C₂₂H₄₆ | 0.004 | 770 | 0.0308 |

Based upon the data in Table 2, the density of the fluid ppis 772 kg m⁻³. As the LPG has a higher density (pₚ=772 kg/m⁻³ than liquid propane (pₚ=493 kg/m⁻³), for a given density of proppant particle, the LPG allows for larger proppant particle to be successfully transported than propane.

FIG. 4 shows a plot of maximum and minimum proppant particle diameter for a given proppant particle density calculated according to Equation 1 for the LPG stimulation fluid, again using the criteria that maximum suspension velocity is 0.143 m s⁻¹ and the minimum suspension velocity 0.108 m s⁻¹. For the SLS glass particles with density pₚ=2500 kg m⁻³, the minimum SLS particle diameter is 150 μm and the maximum SLS particle diameter is 300 μm. Hence, the LPG stimulation fluid can support SLS particles of larger diameter than propane.

The calculations described above may be repeated for any combinations of proppant materials and stimulation fluid to work out the range of proppant particle dimeters of a particular proppant material which would be suitable for transport in a particular stimulation fluid. In this way, it is straightforward to design and manufacture a proppant which is suitable for any kind of fracture stimulation situation, regardless of rock type, fracture size and depth, and operational requirements such as cost and productivity.

Although the suspension velocity relationship has been described as being derived from Newton's equation, the suspension velocity relationship could instead be derived from other physical relationships, such as Stoke's law. Examples of Proppants

### Example 1—Proppant Formulations

A range of proppants were prepared from soda-lime silicate glass of the composition comprising: Si02 74 wt %, Na20 13 wt %, CaO 10.5 wt %, Al2O31.3 wt %, MgO 0.2 wt %

The proppants were prepared according to the fifth aspect of the invention and are described below in Table 3. Further features are provided in Table 5 below.

TABLE 3

| Proppant Name | Physical Features |
|---|---|
| GTS big | Average particle diameter - 563.3 μm, |
| | average sphericity - 0.87. |
| GTS big sieved at 30M | Average particle diameter - 462.2 μm, |
| | average sphericity - 0.87. |
| GTS small | Average particle diameter - 68.2 μm, |
| | average sphericity - 0.89. |
| GTS big annealed | Average particle diameter - 650 μm |
| | (32.5 mesh). |
| GTS 0-63 micro | Average particle diameter - 7.68 μm, |
| | average sphericity - 0.89. |
| GTS 45-90 micro | Average particle diameter - 48.7 μm, |
| | average sphericity - 0.89. |
| GTS 75-150 micro | Average particle diameter - 52.7 μm, |
| | average sphericity - 0.88. |
| GTS 106-212 micro | Average particle diameter - 114.1 μm, |
| | average sphericity - 0.87. |

Proppants used for comparative purposes are described below in Table 4. Further features are provided in Table 6 below.

TABLE 4

| Proppant Name | Composition and Physical Features |
|---|---|
| Sand > 212 micro | Conventional sand composition, average particle |
| | diameter - 220 μm. |
| Sand 106-212 micro | Conventional sand composition, average particle |
| | diameter - 100.8 μm, average sphericity - 0.49. |
| CARBOLITE | Aluminosilicate proppant, average particle diameter - |
| | 864.6 μm, average sphericity - 0.78. |
| Kuhmichel | Pure alumina proppant, average particle diameter - |
| | 290.8 μm, average sphericity - 0.81. |

### Example 2—Proppant Properties

The proppants described in Tables 3 and 4 were analysed according to the following methods.

Sieving Test

Reference: ISO 13503-2 § 6

Method description: J. Getty, Petroleum Engineering, Montana Tech. Overview of Proppants and Existing Standards and Practices.
http://www.astm.org/COMMIT/images/6D_Getty_ProppantTestingStandards_AS T M_Mtg18.26_Jan2013V2.pdf

Modifications:

It was necessary to introduce a modification of the method for the small proppants, due to the size of these materials is consider as fines by the ISO method.

New smaller sizes were chosen for the called “small proppants”, using the fines after the crush test at 4000 psi of GTS big proppant as reference. Around 1 g of the fines was manually sieved at different mesh sizes, finding three different kinds of particles: >200 μm, >125 μm and >50 μm.

The sieves used for “small proppants” are 200 μm (70 Mesh), 125 μm (120 Mesh) and 50 μm (270 Mesh).

Purchased Equipment:
Sieves 20/40 (Endecotts: 008SAW1.18, 008SAW.850, 008SAW.710, 008SAW.600, 008SAW.500, 008SAW.425, 008SAW.300, 0085/STL&R).
Sieves 70/270 (VWR: 510-0708, 510-0718 and 510-0724).
Shaker (Endecotts: MIN200/23050).

Density Test

Reference: ISO 13503-2 § 10

Method description: J. Getty, Petroleum Engineering, Montana Tech. Overview of Proppants and Existing Standards and Practices.
http://www.astm.org/COMMIT/images/6D_Getty_ProppantTestingStandards_AS T M_Mtg18.26_Jan2013V2.pdf

Necessary Materials:
Low density liquid.

Sphericity and Roughness Tests

Reference: ISO 13503-2 § 7

Method description: J. Getty, Petroleum Engineering, Montana Tech. Overview of Proppants and Existing Standards and Practices.
http://www.astm.org/COMMIT/images/6D_Getty_ProppantTestingStandards_AS T M_Mtg18.26_Jan2013V2.pdf

Necessary Equipment:

Scanning Electron Microscope

Crush Tests Reference: ISO 13503-2 § 11

Method description: T. T. Palisch, M. Chapman, R. Duenckel, and S. Woolfolk; CARBO Ceramics, Inc, SPE 119242. How to Use and Misuse Proppant Crush Tests—E i th T 10 M th Exposing the Top 10 Myths.
http://images.sdsmt.edu/learn/John %20Kullman.pdf

Modifications:

The discrimination of the fines for “small proppants” is 270 Mesh, or 53 μm.

Purchased Equipment:
Pneumatic press (Power Tool: CP86150 Compact bench press).
Crushing test cell (Test Resources: GS-13503-2 Test Cell).

Conductivity Tests

Reference: ISO 13503-5

Method description: Petroleum and natural gas industries—Completion fluids and materials—Part 5: Procedures for measuring the long-term conductivity of proppants.
http://www.iso.org/iso/catalogue_detail.htm?csnumber=40531

Alternative Method:

Volumetric flow rate measurement described by S. Alexander et al. (Journal of Colloid and Interface Science 466 (2016) 275-283).

Purchased Equipment:
Pneumatic press (Power Tool: CP86150 Compact bench press).
Conductivity test cell (Matest: A137, A136-01, A137-02, A137-03, A137-04, A141-02).

The results for the proppants identified in Tables 3 and 4 are shown below in Tables 5 and 6, respectively.

TABLE 6

| NAME | Sand > 212 micro | Sand 106-212 micro | CARBOLITE | Kuhmichel |
|---|---|---|---|---|
| Suspension velocity in | 0.001809269 | 0.000380303 | 0.05686776 | 0.0066331 |
| propane (cm/s g) | | | | |
| Particle size | — | 0-212 | 710-1180 | 300-425 |
| distribution (micron) | | | | |
| Particle diameter | 220 | 100.864 | 864.578 | 290.802 |
| (micron) | | | | |
| Density (g/ml) | 1.602 | 1.602 | 2.75 | 2.82 |
| Permeability (mD) | — | 4.36 | 29.71 | 6.22 |
| Crush strength | — | 11.93 | 17.56 | 17.5 |
| (% fines at 6000 psi) | | | | |
| Sphericity | — | 0.49 | 0.78 | 0.81 |
| Roughness | — | 0.12 | 0.87 | 0.465 |

Values underlined were measured as an average of 200 particles from SEM images.

It should be appreciated that the proppants and uses of the invention are capable of being implemented in a variety of ways, only a few of which have been illustrated and described above.

1. A proppant for fracture stimulation, wherein the proppant comprises a plurality of amorphous spherical glass particles which have not undergone any further chemical or thermal treatment.

2. The proppant of claim 1, wherein the density and average diameter of the glass particles are chosen such that the proppant can be transported in a stimulation fluid at velocities in the range of 0.04 m s⁻¹-0.25 m s⁻¹.

3. The proppant of claim 1, wherein the density and average diameter of the glass particles are chosen such that the proppant can be transported in a stimulation fluid at velocities in the range of 0.01 m s⁻¹-0.16 m s⁻¹.

4. The proppant of claim 1, wherein the proppant has a particle diameter in the range 40 μm-500 μm.

5. The proppant of claim 1, wherein the proppant has a density in the range 0.9-2.5 g cm⁻³.

6. The proppant of claim 1, wherein the glass is selected from a soda-lime silicate glass, a borosilicate glass or a phosphate glass.

7. The proppant of claim 6, wherein the glass is a soda-lime silicate glass.

8. The proppant of claim 1, wherein the particle size distribution of the glass particles is in the range of 50 μm-125 μm.

9. The proppant of claim 1, wherein the glass particles have a crush strength of 0.01 MPa-55 MPa at 2000 psi-8000 psi.

10. The proppant of claim 1, wherein the glass particles have a sphericity of ≥0.70, preferably ≥0.85.

11. The proppant of claim 1, wherein the glass particles have a roundness of ≥0.70, preferably ≥0.85.

12. The proppant of claim 1, wherein the crystallinity of the glass particles is less than about 5 vol %, preferably less than about 3 vol %, more preferably less than about 1 vol %.

13. The proppant of claim 1, wherein the conductivity of the proppant, in use, is in the range 5 mDa-100 mDa.

14. The proppant of claim 1, wherein the glass particles contain bubbles, pores or voids.

15. The proppant of claim 1, wherein the glass particles are solid glass particles.

16. The proppant according to claim 1, wherein the glass particles have a particle size and density falling between the upper and lower boundaries shown in either of FIG. 3 or 4.

17-41. (canceled)
